(19) United States
(12) Patent Application Publication
(10) Pub. No.: US 2007/0240194 A1
(43) Pub. Date: Oct. 11, 2007

(54) SCOPED PERMISSIONS FOR SOFTWARE APPLICATION DEPLOYMENT

(76) Inventors: Bentley J. Hargrave, Deland, FL (US); Benjamin C. Reed, Morgan Hill, CA (US); Peter Kriens, Baillargues (FR)

Correspondence Address: Greg Goshorn, P.C., 9600 Escarpment, Suite 745-9, AUSTIN, TX, 78749, US

(21) Appl. No.: 11/277,665

(22) Filed: Mar. 28, 2006

(51) Int. Cl. H04L 9/00

(52) U.S. Cl. 726/1

(57) ABSTRACT

Provided is a method for defining security permissions in a computer application in a manner that distributes the assignment of security permissions among multiple levels of the software development and delivery process. A developer defines the permissions for a particular application as metadata and saves the permissions in a permissions metadata file stored in conjunction with the application. A signer inspects the application and permissions file and, if satisfied that the appropriate permission levels in the file have been properly set, validates, or “signs,” the application. Once a signer has validated, or signed, the permissions in the application and the permissions file, the application is deployed, or provided to a user who installs the application on a computing system with the maximum permissions allowed under the permissions file. The user can further limit the scope of the permissions granted by the developer by adding a policy file to the application

### TECHNICAL FIELD

The present invention relates generally to computer security and, more specifically, to a method for defining security permissions in computer applications.

### BACKGROUND OF THE INVENTION

With the advent of the Internet, sometimes referred to as the “web,” businesses and consumers have multiple channels for the development and delivery of software applications not previously available. The distribution of applications across multiple levels of business entities creates issues of trust between the entities. For example, a deployer, who implements an application in a business, must trust a signer, who verifies the integrity of the application, who in turn must trust a developer, who writes the code of the application Companies, such as International Business Machines Corporation (IBM) of Armonk, N.Y., have developed security procedures that facilitate the deployment, integration, execution and management of software applications.

Currently, one common approach to the issue of computer security is to deploy a Java2 security model to ensure the integrity of applications in a runtime environment. One problem with Java2 security is the process for defining precise security permissions is cumbersome.

In Windows, published by the Microsoft Corporation of Redmond, Wash., application permissions are based upon zones or groups. Different security zones are defined and the primary decision within a particular zone is whether or not to run a specific application based upon the application's security permission settings. Once the decision is made to allow an application to run, the running application typically gets all the permissions corresponding to the zone. Further, security zones are not useful in a Java environment because the permissions are too finely grained. In other words, this finely-grained, all or nothing approach requires that the system administrator or other users who deploy the application have access to detailed security configuration information and prevents users from setting different levels of security for different applications within a particular zone.

Java2 security employs permission checking to enforce a security policy. The J2EE runtime environment default Java2 security policy allows J2EE applications a very limited set of permissions to ensure runtime integrity. A user who deploys an application must set the permission level for the application. As mentioned above, this approach requires that the user who deploys the application have detailed information about how an application is to be used and by whom.

What is needed is system that distributes the setting of security policies among the people responsible for developing, signing and deploying an application. At each level, personnel have different perspectives on the security needs and a distributed approach would enable the personnel at each level to address their particular security concerns.

### SUMMARY OF THE INVENTION

Provided is a method for defining security permissions in a computer application in a manner that distributes the assignment of security permissions among multiple levels of the software development and delivery process Levels include, but are not limited to, developers, application signers and personnel who deploy an application. By creating a permissions file, a developer can specify the maximum permissions applicable to a particular application. The signer can then further limit the application's permissions depending upon the signer's knowledge of the system. Finally, a user who deploys the application can assert control over the specific permissions assigned to various users.

A developer defines the permissions for a particular application as metadata in the application and saves the permissions in a permissions metadata file stored in conjunction with the application. A signer inspects the application and permissions file and validates, or “signs,” the application if satisfied that the appropriate permission levels in the file have been properly set. Once a signer has validated, or signed, the permissions in the application and the permissions file, the application is deployed, or provided to a user who installs the application on a computing system with the maximum permissions allowed under the permissions file. A deployed application is given the permissions specified in the metadata, but limited to the permissions the user has associated with the signer and defined in a policy file. In other words, when the application is executed, a runtime check ensures that the application can only perform actions that are both permitted by the permissions file, as vouched for by the signer, and permitted by the policy file as defined by personnel who deploy the application, based upon the maximum trust that the person who deploys the application has placed in the signer.

One advantage of the disclosed technology is that the signer can limit liability. For example, if the signer determines that a particular bundle is not very trustworthy, the signer may sign the bundle only within a small security scope. A signer can also use the same certificate for different trust levels, thus simplifying computer administration. In addition, a system administrator or other user can inspect a permissions file prior to deployment to determine the permissions needed for execution. The claimed subject matter also enables the system administrator to limit the maximum security scope an application from a particular signer receives.

This summary is not intended as a comprehensive description of the claimed subject matter but, rather, is intended to provide a brief overview of some of the functionality associated therewith. Other systems, methods, functionality, features and advantages of the invention will be or will become apparent to one with skill in the art upon examination of the following figures and detailed description.

### BRIEF DESCRIPTION OF THE FIGURES

A better understanding of the present invention can be obtained when the following detailed description of the disclosed embodiments is considered in conjunction with the following figures, in which:

FIG. 1 is a block diagram of an exemplary computing system that incorporates the claimed subject matter.

FIG. 2 is a block diagram of an exemplary application development architecture, including distribution elements, that employs the claimed subject matter.

FIG. 3 illustrates an exemplary permissions file that may be employed in one embodiment of the claimed subject matter.

FIG. 4 is flowchart of an application development and deployment process associated with the claimed subject matter.

FIG. 5 is a flowchart of a runtime process that executes an application developed according to the claimed subject matter.

### DETAILED DESCRIPTION OF THE FIGURES

Although described with particular reference to a Windows operating system (OS) and a Java development environment, the claimed subject matter can be implemented in any information technology (IT) system in which flexible application security is desirable. Those with skill in the computing arts will recognize that the disclosed embodiments have relevance to a wide variety of computing environments in addition to those described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory an recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

One embodiment, in accordance with the claimed subject, is directed to a programmed method for implementing software application security. The term “programmed method”, as used herein, is defined to mean one or more process steps that are presently performed; or, alternatively, one or more process steps that are enabled to be performed at a future point in time. The term programmed method anticipates three alternative forms. First, a programmed method comprises presently performed process steps. Second, a programmed method comprises a computer-readable medium embodying computer instructions, which when executed by a computer performs one or more process steps. Finally, a programmed method comprises a computer system that has been programmed by software, hardware, firmware, or any combination thereof, to perform one or more process steps. It is to be understood that the term “programmed method” is not to be construed as simultaneously having more than one alternative form, but rather is to be construed in the truest sense of an alternative form wherein, at any given point in time, only one of the plurality of alternative forms is present.

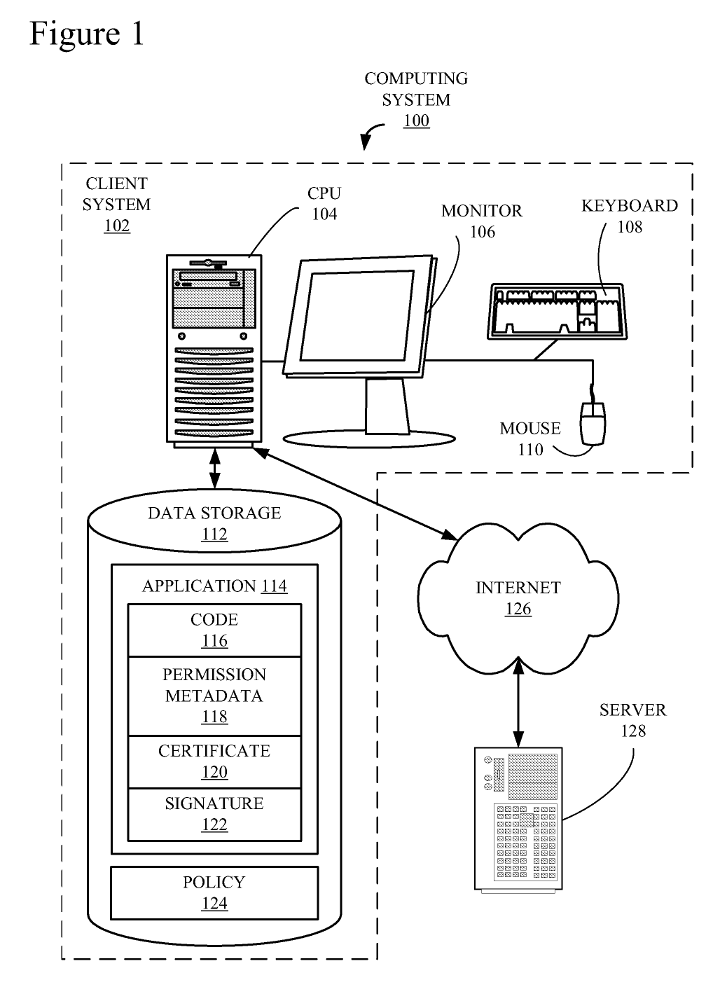

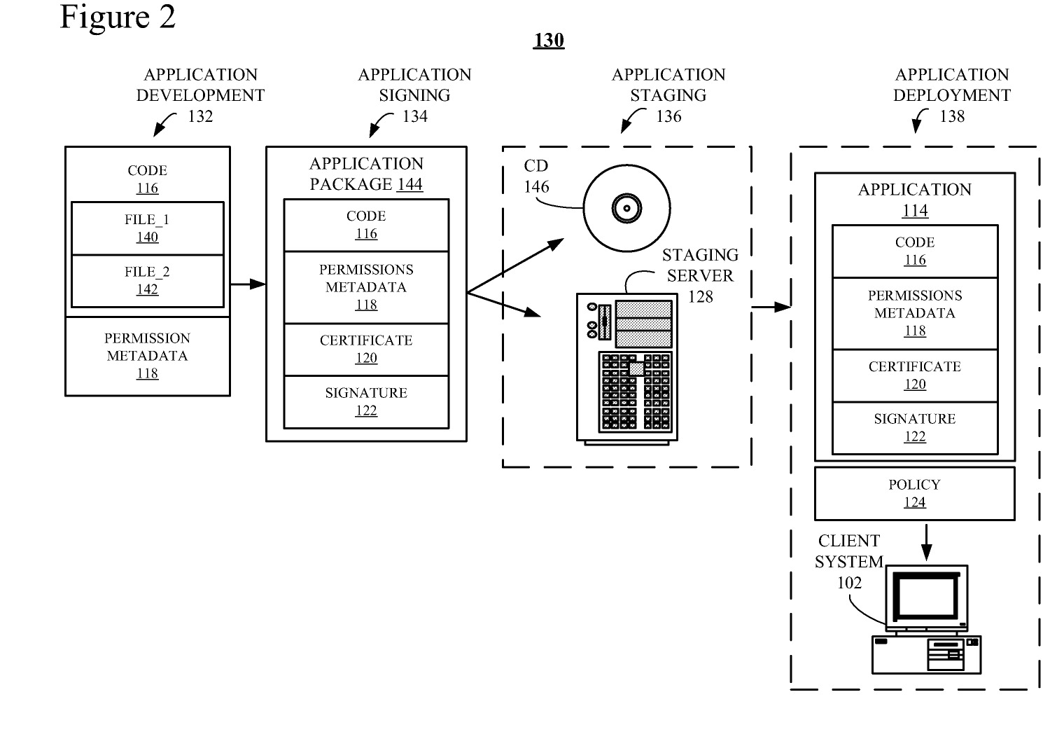

Turning now to the figures, FIG. 1 is a block diagram of an exemplary computing system architecture 100 that incorporates the claimed subject matter. A client system 102 includes a central processing unit (CPU) 104, coupled to a monitor 106, a keyboard 108 and a mouse 110, which together facilitate human interaction with computing system 100 and client system 102. Also included in client system 102 and attached to CPU 104 is a data storage component 112, which may either be incorporated into CPU 104 i.e. an internal device, or attached externally to CPU 104 by means of various, commonly available connection devices such as but not limited to, a universal serial bus (USB) port (not shown). Data storage 112 is illustrated storing an exemplary computer software application 114 that incorporates the claimed subject matter. Application 114 includes several components, i.e. code 116, a permissions metadata file 118, a certificate 120 and a signature 122. A policy file 124 is also stored on data storage 112. Although shown in conjunction with application 114, policy file 124 is deployed separately form application 114 and is not specific to application 114. In other words, typically policy file 124 defines a policy for a computer system rather than for a specific application. It should be noted that a typical computing system would include more than one application, but for the sake of simplicity only one is shown. Components 118, 120, 122 and 124 represent components of a security system that provide a distributed and flexible security policy for addressing the security issues described above in the Background of the Invention. Components 118, 120, 122 and 124 are described in more detail below in conjunction with FIGS. 2-5.

Client system 102 and CPU 104 are connected to the Internet 126, which is also connected to a server computer 128. Although in this example, CPU 104 and server 128 are communicatively coupled via the Internet 126, they could also be coupled through any number of communication mediums such as, but not limited to, a local area network (LAN) (not shown). Further, it should be noted there are many possible computing system configurations, of which computing system 100 is only one simple example.

FIG. 2 is a block diagram of a solution, or application, development system 130 that employs the claimed subject matter. Client system 102, code 116, server, or “staging server,” 128 of FIG. 1 are included in this figure. As in FIG. 1, application 114 includes code 116, permissions metadata 118, certificate 120 and signature 122. This figure illustrates the creation of application 114 through development system 130.

In this example in which a developer delivers custom business solutions to particular software markets, the process is illustrated as broken into four (4) exemplary phases: application development 132, application certification, or signing, 134; application staging 136 and application deployment 138.

During application development 132, a developer creates code 116 and defines a permission metadata file 118 that is associated with code 116. Code 116 includes exemplary files; i.e. a file_1 140 and a file_2 142. For the sake of simplicity, file_1 140 and file_2 142 are only shown in code 116 during one stage of the development process 130, although it should be understood that files 140 and 142 are part of code 116 throughout phases 134, 136 and 138 as well.

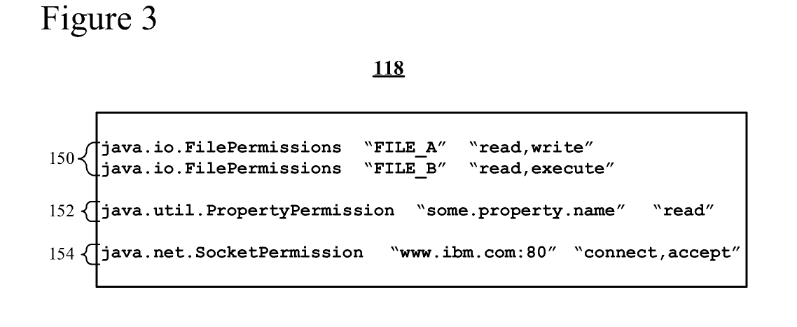

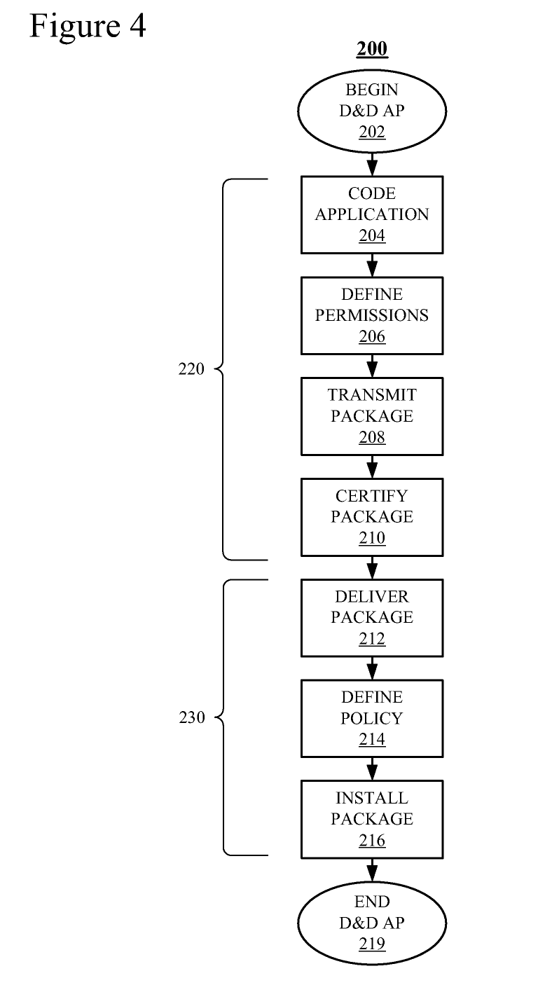

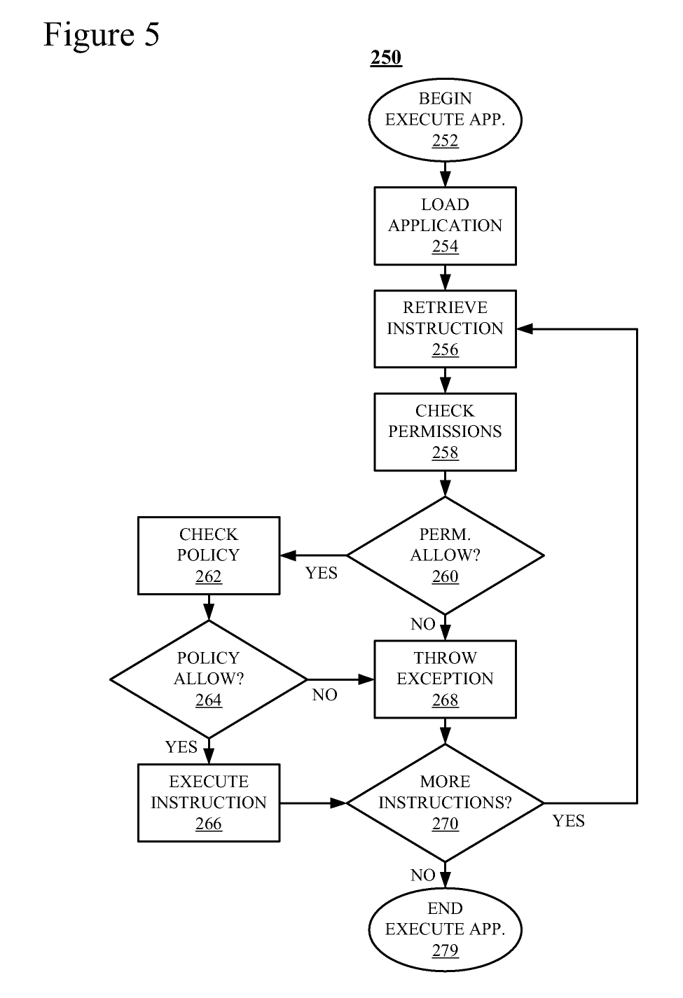

An exemplary permissions metadata file 118 is described in more detail below in conjunction with FIG. 3. The process of employing permissions metadata file 118 is described in detail below in conjunction with FIGS. 4 and 5. The development of code 116 may include, but is not limited to, the writing of custom computer code and the incorporation of third party code and software products. In other words, code 116 may include any number of separate components, each of which may be off-the-self products, created by technical experts, or developed by third party vendors. File_1 140 and file_2 142 are two (2) such components. It should be noted that files 140 and 142 are used for the purposes of illustration only; a typical application 114 and the corresponding code 116 would include many files and components. For the sake of simplicity, only file_1 140 and file_2 142 are shown.

During application signing 134, a trusted party, such as a system administrator, inspects code 116 and permissions metadata file 118 and, if security requirements are met, certifies code 116 and file 118 by adding a certificate 120 and a corresponding signature 122. Prior to certification, additional files (not shown) may be included with code 116 and permissions metadata file 118. Once certified, code 116, permissions metadata file 118, certificate 120 and signature 122 become part of application package 144 and can not be modified without invalidating certificate 120 and signature 122. In other words, if code 116 or any of the component parts such as files 140 or 142 are modified, code 116 and permissions metadata file 118 must be recertified by inserting a new certificate 120 and signature 122. Thus, certificate 120 and signature 122 of application package 144 enable a system administrator or other authorized user to deploy application package 144 with the knowledge that application package 144 has been screened for security purposes.

Certificate 120 is a means by which the system administrator or other authorized user, or “signer,” is identified. Certificate 120 contains a public key corresponding to the signer with the certificate chain. Certificate 120 may be presented in different applications as evidence of the identity of the signer. Each signed application has a different signature 122, based upon the contents of the application, such as application 114, and certificate 120 used to sign the application. In fact, different versions of an application have different signatures because the content of the versions differ, if even slightly. Thus signature 122 performs two (2) functions, i.e. it can be used to validate that certificate 120 was used to create signature 122 and also to verify that the contents of application 114 and any other application with which certificate 120 is associated. The process of inspecting, certifying and signing applications for security purposes should be familiar to those with skill in the computing and cryptographic arts.

Application staging 136 illustrates some methods of distributing application package 144 to an eventual client or customer. Examples of such distribution techniques include, but are not limited to, compact disk (CD) 146, which is mailed or otherwise delivered to the customer for installation on a customer system, e.g. client system 102; and staging server 128, from which client system 102 can download a product or solution, such as application package 144. Those with skill in the computing arts should recognize that there are many possible delivery options in addition to CD 146 and staging server 128.

During application deployment 138, a system administrator or other personnel responsible for client system 102 loads application package 144 onto data storage 112. Once deployed, application 114 is given, at most, the permissions specified in the permissions metadata file 118. The system administrator or other user who deploys application 114, after inspecting code 116 and permissions metadata file 118, adds policy file 124 to address any security concerns the administrator may have. When application 114 is executed, a runtime check ensures that application 114 can only perform actions that are both permitted by permissions metadata file 118, as vouched for by the signer, and permitted by policy file 124, as defined by the personnel who deploys application 114. In this manner, personnel in phases 132, 134 and 138 all have control over the ultimate permissions accorded to application 114 based upon their individual needs and concerns. Specifically, the system administrator, during application deployment phase 138 can limit application 114 based upon the maximum trust that the administrator places on the signer who created certificate 120 and signature 122 during application signing phase 134. For example, if the administrator does not particularly trust either the developer of the signer, application can still be granted very limited permissions and allowed to execute.

FIG. 3 illustrates an exemplary permissions metadata file 118, first introduced above in conjunction with FIGS. 1 and 2, which may be employed in one embodiment of the claimed subject matter. Permissions metadata file 118 includes “file” entries 150, “property” entries 152 and “system” entries 154. File entries 150 define access permissions associated with various files associated with code 116 (FIGS. 1 and 2), which in this example include file_1 140 and file_2 142, both introduced above in conjunction with FIG. 2. Property entries 152 define access rights for various properties that may be associated with the computing system and application 114. System entries 154 define, among other things, access parameters for various remote computing devices that may be employed to access the system on which application 114 is installed. In the following examples, application 114 is installed on client system 102 and remote access is permitted from server 128.

File entries 150 includes two (2) exemplary lines: a first line, “java.io.FilePermission “FILE_A” ‘read,write’,” which refers to an exemplary file_A (not shown) and a second line, ‘java.io.FilePermission “FILE_B” “read,execute”,’ that refers to an exemplary data file_B (not shown). The syntax of lines in file entries 150 is the first entry, e.g. “jave.io.FilePermissions,” specifies the type of permission, the second entry, e.g. “FILE_A,” is the name of the entity to which the permissions applies, and the third entry, e.g. “read,write,” specifies the permitted actions permitted with respect to the corresponding file. For example, in the first line, the phrase “java.io.FilePermission” specifies that the entry refers to java input/output (I/O) permissions. The term “FILE_A” specifies the corresponding data file. The phrase “read,write” indicates that FILE_A can be read and written to by a user or application. Simply stated, file_A is listed as an ordinary file to which users and applications can read and write.

Property entries 152 include one (1) exemplary line, ‘java.io.PropertyPermission “some.property.name” “read”.’ Like in file entries 150, the first phrase, e.g. “java.io.PropertyPermission,” specifies the type of permission, the second entry, e.g. “some.property.name,” is the name of the entity to which the permissions applies, and the third entry, e.g. “read,” specifies the permitted actions permitted with respect to the corresponding property. In other words, the line ‘java.io.PropertyPermission “some.property.name” “read”’ specifies that the entry refers to java input/output (I/O) permissions for properties. The term “some.property.name” specifies the property defined. The phrase “read” indicates that the corresponding property can be read by a user or application.

System entries 154 includes one (1) exemplary line, ‘java.net.SocketPermission “www.ibm.com:80” “connect,accept”.’ The syntax of lines in system entries 154 is similar to the syntax of file entries 150 and property entries 152. For example, the one line in this example of system entries 154 indicates the host, in this example, port 80 of “www.ibm.com” is permitted to connect to and accept connections.

It should be understood the file 118 is only one example of a permissions metadata file that may be employed to implement the claimed subject matter. One with skill in the computing arts should appreciate that there are numerous formats and types of entries that could be incorporated into the system described herein. The format and meaning of the entries in entries 150, 152 and 154 are used only as examples. Further, the syntax and meaning should be familiar to those with skill in the computing arts.

FIG. 4 is flowchart of an application development and deploy (D&D) process 200 associated with the claimed subject matter. In accordance with the disclosed technology, actions associated with process 200 are distributed among several personnel in application development and deploy process 130 (FIG. 2). For example, the application can be signed by a developer prior to transmission or signed by someone other than the developer after transmission. When relevant, the parties typically responsible for particular actions will be described.

Process 200 starts in a “Begin Develop and Deploy (D&D) Application Package (AP)” block 202 and control proceeds immediately to a “Code Application” block 204. During block 204, an application developer writes and/or assembles the code 116 (FIGS. 1 and 2) for a particular application. As described above, the development of code 116 may include, but is not limited to, the writing of custom computer code and the incorporation of third party code and software products. In other words, code 116 may include any number of separate components, each of which may be off-the-self products, created by technical experts, or developed by third party vendors. File_1 140 (FIG. 2) and file_2 142 (FIG. 2) are two (2) such components.

During a “Define Permissions” block 206 after code has been produced during block 204, the application developer produces a permissions metadata file such as file 118 (FIGS. 1-3). During a “Transmit Package” block 208, the developer delivers code 116 and file 118 as application package to a signer who verifies the source of package. Block 208 corresponds to the transition from application development 132 (FIG. 2) to application signing 134 (FIG. 2).

During a “Certify Package” block 210, a signer inspects code 116 and permissions metadata file 118 and validates, or “signs,” them if satisfied that the appropriate permission levels, such as those described above in conjunction with FIG. 3, in the file have been properly set. The signing of the application is performed by incorporating certificate 120 and signature 122 with code 116 and permissions metadata file 118 to produce application package 144 (FIG. 2).

Once the signer has validated, or signed, the application and permissions file during block 210, the application is delivered to the end user during a “Deliver Package” block 212. Block 212 corresponds to the transition from application signing 134 through application staging 136 (FIG. 2) to application deployment 138 (FIG. 2). During a “Define Policy” block 214, the system administrator, or user responsible for computing system 102 (FIGS. 1 and 2), inspects permissions metadata file 118 and determines whether or not the defined permissions are appropriate. If the system administrator determines that modifications are required, policy file 124 (FIGS. 1 and 2) is amended. During an “Install Package” block 216, application package 144 is installed on computing system 102 to create the final application 114 (FIGS. 1 and 2).

Finally, process 200 proceeds to an “End D&D AP” block 219 in which process 200 is complete. In this example, although illustrated as a single process 200, blocks 204, 206, 208 and 210 can be characterized as part of a development process 220 and blocks 212, 214 and 216 as part of a deployment process 230. In other words, process 220 and process 230 are distinct process that may be executed by different entities on different computing systems and are shown as part of a single process 200 merely for the sake of convenience. It should be understood that during development and deployment process 200, each of blocks 204, 206, 208, 210, 212, 214 and 216 may be entered multiple times. For example, the signer during block 210 may determine that permissions metadata file 118 is either insufficient or too restrictive and return code 116 and permissions metadata file 118 to the developer for modification.

FIG. 5 is a flowchart of a runtime process 250 that executes application 114. In this example, process 250 is stored on data storage 112 (FIG. 1) and executes on CPU 104 (FIG. 1). In one embodiment and the following examples, process 250 is incorporated into a Java runtime environment (JRE) (not shown), published by Sun Microsystems, Incorporated of Santa Clara, Calif.

Process 250 starts in a “Begin Execute Application (App.)” block 252 and control proceeds immediately to a “Load Application” block 254. During block 254, process 250 loads application 114 (FIGS. 1 and 2) into CPU 104. During a “Retrieve Instruction” block 256, process 250 gets the first unexecuted instruction in application 114. Each time process 250 enters block 256, the instruction retrieved is referred to in the following description as the “current” instruction.

During a “Check Permissions” block 258, process 250 scans permissions metadata file 118 associated with application 114 for information relevant to the instruction retrieved during block 256. For example, if the current instruction calls for the writing to a particular directory of data storage 112, process 250 determines scans file entries 150 (FIG. 3) for a reference to the particular directory and the user who initiated application 114. During a “Permissions (Perm.) Allow?” block 260, process 250 determines whether or not permissions file 118 allows or disallows the execution of the current instruction. If file 118 allows execution, process 250 proceeds to a “Check Policy” block 262 during which policy file 124 is scanned for information relevant to the current instruction.

During a “Policy Allow?” block 264, process 250 determines whether or not policy file 124 allows or disallows the execution of the current instruction. If file 124 allows execution, process 250 proceeds to an “Execute Instruction” block 266 during which the JRE executes the instruction.

If, either during Permissions Allow? block 260 or during Policy Allow? Block 264, process 250 determines that execution of the current instruction would violate either of files 118 or 124, respectively, process 250 proceeds to a “Throw Exception” block 268. During block 268, the JRE takes appropriate action to recover from the execution denial. Depending upon how exceptions are handled this might include notice to the person who initiated the execution of application 114 and/or termination of application 114. In this example, after handling the exception thrown during block 268, the JRE takes appropriate action, simply retrieves the next instruction and proceeds with processing. The programming and use of thrown exceptions should be familiar to those with skill in the programming arts.

Following the execution of the current instruction during block 266 or, in this example, the throwing of an exception during block 268, process 250 proceeds to a “More Instructions?” block 270 during which process 250 determines whether or not there are additional unexecuted instruction in application 114. If so, process 250 returns to block 256, retrieves the next instruction and processing continues as described above. If process 250 determined that there are no unexecuted instructions, control proceeds to an “End Execute App.” block 279 in which process 250 and application 114 is complete.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order.

We claim:

1. A method for setting security parameters in a software application, comprising:
setting metadata security parameters corresponding to a software application;
securely signing the application and the metadata security parameters upon verification of the application and the metadata security parameters;
setting deployment security parameters corresponding to a level of trust a deployer of the software application has with the signer of the application and the metadata security parameters; and
deploying the application at a security level associated with the lesser of security levels represented by the metadata security parameters and the deployment security parameters.

2. The method of claim 1, further comprising setting signer security parameters, wherein the security level of deployment is the greater of security levels represented by the metadata, signer and deployment security parameters.

3. The method of claim 1, wherein the metadata and deployment security parameters correspond to levels of security for computer code.

4. The method of claim 1, further comprising executing a runtime check on an instruction of the software application to ensure that the security level required by the instruction does not exceed the deployed security level.

5. The method of claim 4, wherein the runtime check is executed by a JAVA runtime engine.

6. The method of claim 1, wherein the metadata security parameters and the deployment security parameters are in conformity with a Java security policy.

7. The method of claim 1, wherein the metadata security parameters are defined ay a developer of the software application.

8. A system for setting security parameters in a software application, comprising:
metadata security parameters corresponding to a software application;
a certificate and a signature corresponding to the software application verifying the software application and the metadata security parameters;
deployment security parameters corresponding to a level of trust a deployer of the software application has with a signer who generated the certificate and signature; and
logic for deploying the application at a security level associated with the lesser of security levels represented by the metadata security parameters and the deployment security parameters.

9. The system of claim 8, further comprising signer security parameters defined by the signer, wherein the logic for deploying sets the security level of deployment at the lesser of security levels represented by the metadata and deployment security parameters.

10. The system of claim 8, wherein the metadata and deployment security parameters correspond to levels of security for computer code.

11. The system of claim 8, further comprising a runtime check performed on an executing instruction of the software application to ensure that the security level required by the instruction does not exceed the deployed security level.

12. The system of claim 11, wherein the runtime check is executed by a JAVA runtime environment.

13. The system of claim 8, wherein the metadata security parameters and the deployment security parameters are in conformity with a Java security policy.

14. The system of claim 8, wherein the metadata security parameters are defined ay a developer of the software application.

15. A service for distribution of secure applications having security permissions set by an application developer, comprising:
metadata security parameters corresponding to a software application;
logic for securely signing the application and the metadata security parameters upon verification of the application and the metadata security parameters;
deployment security parameters corresponding to a level of trust a deployer of the software application has with the signer of the application and the metadata security parameters; and
logic for deploying the application at a security level associated with the lesser of security levels represented by the metadata security parameters and the deployment security parameters.

16. The service of claim 15, further comprising signer security parameters, wherein the logic for deploying the application applies a security level of deployment at a security level that is the lesser of security levels represented by the metadata and deployment security parameters.

17. The service of claim 15, wherein the metadata and deployment security parameters correspond to levels of security for computer code.

18. The service of claim 15, further comprising logic for executing a runtime check on an instruction of the software application to ensure that the security level required by the instruction does not exceed the deployed security level.

19. The service of claim 18, wherein the runtime check is executed by a JAVA runtime environment.

20. The service of claim 15, wherein the metadata security parameters are defined ay a developer of the software application.
